(19) United States
(12) Patent Application Publication
(10) Pub. No.: US 2018/0148601 A1
(43) Pub. Date: May 31, 2018

(54) ABRASION RESISTANT COATING COMPOSITION WITH INORGANIC METAL OXIDES

(71) Applicant: MOMENTIVE PERFORMANCE MATERIALS INC., Waterford, NY (US)

(72) Inventors: Karthikeyan Murugesan, Bangalore (IN); Indumathi Ramakrishnan, Bangalore (IN); Robert Hayes, Mechanicville, NY (US)

(21) Appl. No.: 15/634,123

(22) Filed: Jun. 27, 2017

Related U.S. Application Data
(60) Provisional application No. 62/427,853, filed on Nov. 30, 2016.

(51) Int. Cl. C09D 183/04; C09D 5/32; C09D 5/00

(52) U.S. Cl. CPC C09D 183/04; C08K 2003/2213; C09D 5/00; C09D 5/32

(57) ABSTRACT

The present technology provides a coating system including an inorganic UV-absorbing material and a catalyst. The inorganic UV-absorbing material is chosen from cerium oxide, titanium oxide, zinc oxide, or combinations of two or more thereof. The inorganic material may be provided ranging from 1 wt. % to about 50 wt. % based on the dry weight of film after curing the coating system. The catalyst is provided in an amount ranging from 1 ppm to about 75 ppm. The coating system may include a topcoat material, a primer material, or a combination thereof.

### CROSS-REFERENCE TO RELATED APPLICATIONS

This Application claims priority to and the benefit of U.S. Provisional Application No. 62/427,853 filed on Nov. 30, 2016, the disclosure of which is incorporated herein by reference in its entirety

### FIELD

The disclosed subject matter relates to coating compositions or systems for coating a variety of substrates. In particular, the subject matter relates to a coating composition that provides an abrasion resistant coating, such as, for example, a hardcoat formulation.

### BACKGROUND

Polymeric materials, particularly thermoplastics such as polycarbonate, are promising alternatives to glass for use as structural material in a variety of applications, including automotive, transportation, and architectural glazing applications, where increased design freedom, weight savings, and improved safety features are in high demand. Plain polycarbonate substrates, however, are limited by their lack of abrasion, chemical, ultraviolet (UV), and weather resistance, and, therefore, need to be protected with optically transparent coatings that alleviate above limitations in the aforementioned applications.

Silicone hardcoats have been traditionally used to improve the abrasion resistance and UV resistance of various polymers including polycarbonate and acrylics. This enables the use of polycarbonates in a wide range of applications, including architectural glazing and automotive parts such as headlights and windshields.

The addition of a thermally curable silicone hardcoat generally imparts abrasion resistance to the polymeric substrate. The addition of organic or inorganic UV-absorbing materials in the silicone hardcoat layer can improve the weatherability of the polymeric substrate. The incorporation of organic UV absorbers in the silicone hardcoat layer, however, often leads to reduction in abrasion resistance performance. One approach to address the reduction in abrasion resistance performance associated with the use of organic UV-absorbing materials is to use inorganic UV-absorbing materials at least partially in place of organic UV-absorbing materials. However, other properties such as optical clarity, adhesion, and abrasion resistant characteristics of the coating may suffer when using the inorganic UV-absorbing materials. Additionally, it is difficult to (a) retain stability of the coating before applying to a substrate, and (b) prevent agglomeration of the inorganic nanoparticles after application to the substrate.

### SUMMARY

The present technology provides a coating system comprising an inorganic material as a UV-absorbing material. The coatings employ an inorganic UV-absorbing material and provide a coating with good weatherability while also providing good abrasion resistance, optical clarity, and adhesion. It has been found that coatings with desirable weatherability and abrasion resistance may be provided by controlling the concentration of the UV absorbing material and the cure catalyst employed in the coating system. In another embodiment, controlling the concentration of silicone resin and/or silica may also improve the weatherability, abrasion resistance, optical clarity, and adhesion of the coating system. Weatherability may be defined as the outdoor service life time of a coated article while maintaining the initial coating properties like transmission, Haze, adhesion and abrasion resistance. It can be measured through the weathering studies done under accelerated climate conditions involving radiation, temperature and humidity changes using a Weatherometer.

In one aspect, the present technology provides a coating system comprising a curable silicone hardcoat composition, silica, an inorganic UV-absorbing material, and a cure catalyst.

In one embodiment, the coating system comprises (a) at least one curable silicone resin material, (b) from about 1 wt. % to about 50 wt. % of at least one inorganic UV-absorbing material based on the dry weight of a film after curing the coating system, and (c) from about 1 ppm to about 75 ppm of at least one catalyst.

In one embodiment, the inorganic UV-absorbing material is chosen from cerium oxide, titanium oxide, zinc oxide, or a combination of two or more thereof.

The coating system of any previous embodiment, wherein the catalyst is chosen from tetrabutylammonium carboxylate, tetra-n-butylammonium acetate (TBAA), tetra-n-butylammonium formate, tetra-n-butylammonium benzoate, tetra-n-butylammonium-2-ethylhexanoate, tetra-n-butylammonium-p-ethylbenzoate, and tetra-n-butylammonium propionate, tetra-n-butylammonium acetate, tetra-n-butylammonium formate, tetramethylammonium acetate, tetramethylammonium benzoate, tetrahexylammonium acetate, dimethylanilium formate, dimethylammonium acetate, tetramethylammonium carboxylate, tetramethylammonium-2-ethylhexanoate, benzyltrimethylammonium acetate, tetraethyl ammonium acetate, tetraisopropylammonium acetate, triethanol-methylammonium acetate, diethanoldimethylammonium acetate, monoethanoltrimethylammonium acetate, ethyltriphenylphosphonium acetate or combinations of two or more thereof.

The coating system of any previous embodiment, wherein the inorganic UV-absorbing material is provided in an amount ranging from about 1 wt. % to about 50 wt. % based on the dry weight of film after curing the coating system.

The coating system of any previous embodiment, wherein the inorganic UV-absorbing material is provided in an amount ranging from about 7 wt. % to about 40 wt. % based on the dry weight of film after curing the coating system.

The coating system of any previous embodiment, wherein the inorganic UV-absorbing material is provided in an amount ranging from about 10 wt. % to about 30 wt. % based on the dry weight of film after curing the coating system.

The coating system of any previous embodiment, wherein the inorganic UV-absorbing material is provided in an amount ranging from about 14 wt. % to about 20 wt. % based on the dry weight of film after curing the coating system.

The coating system of any previous embodiment, wherein the catalyst is provided in an amount ranging from about 1 ppm to about 75 ppm.

The coating system of any previous embodiment, wherein the catalyst is provided in an amount ranging from about 10 ppm to about 70 ppm.

The coating system of any previous embodiment, wherein the catalyst is provided in an amount ranging from about 20 ppm to about 60 ppm.

The coating system of any previous embodiment, wherein the coating system comprises a silicone hardcoat, an optional primer material, or a combination thereof.

In one embodiment, the silicone hardcoat comprises the inorganic UV-absorbing material, and catalyst.

In one aspect, the present technology provides a coated article comprising a polymeric substrate, and a coating system according to any of the previous embodiments disposed on at least a portion of a surface of the substrate.

In one aspect, the present technology provides a method of forming a curable silicone hardcoat composition comprising adding (i) from about 1 wt. % to about 50 wt. % of at least one inorganic UV-absorbing material based on the dry weight of a film after curing the composition, and (ii) from about 1 ppm to about 75 ppm of at least one catalyst to a curable silicone material.

In a further aspect, the present technology provides a method of preparing a coated article comprising: applying a silicone hardcoat composition to at least a portion of a surface of an article, the silicone hardcoat composition comprising a) at least one curable silicone resin material, (b) from about 1 wt. % to about 50 wt. % of at least one inorganic UV-absorbing material based on the dry weight of a film after curing the coating system, and (c) from about 1 ppm to about 75 ppm of at least one catalyst; and curing the silicone hardcoat composition to form a cured coating layer.

In one embodiment, the cured coating layer is further treated by a vacuum deposition processes.

These and other aspects and embodiments of the present technology are further understood and described with reference to the following detailed description.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more,” “at least one,” etc. unless context suggest otherwise.

The present technology provides a coating composition or system with an inorganic UV-absorbing material that can exhibit excellent abrasion resistance and weatherability. The coatings can be used to coat a variety of substrates such as, but not limited to, polycarbonates and acrylics as a topcoat to provide abrasion resistance. In particular, it has been found that by controlling the concentrations of the inorganic UV-absorbing material and the catalyst that facilitates curing of the coating, inorganic UV-absorbing materials may be incorporated in the coating compositions to provide a coating with excellent weatherability and abrasion resistant properties.

In an embodiment, the coating compositions comprise a material suitable for forming an abrasion resistant coating, an inorganic filler material, and a catalyst for curing the composition. The coating composition may be configured to provide a relatively hard coating that may provide abrasion resistance and/or other desirable properties to the substrate. In an embodiment, the coating system comprises an outer (topcoat) layer and optional primer layer. Depending on the nature of the coating composition and the substrate to be coated, a primer layer or coating may need to be applied over the substrate to promote adhesion of the outer protective coating or topcoat layer. As used herein, the phrase “coating system” may refer to a topcoat layer alone or it may refer to a topcoat layer in combination with the primer layer, as well as any other additional layers that may be included.

The inorganic UV-absorbing material can be added to the topcoat formulation as desired for a particular purpose or intended application. In one embodiment, the inorganic UV-absorbing material can be chosen from cerium oxide, titanium oxide, zinc oxide, or a combination of two or more thereof. Generally, the inorganic material should be present in an amount that will not affect or impair the physical properties of the coating including, for example, the optical properties of the coating system, but in a sufficient amount effective to provide sufficient weatherability to the coating depending on the performance requirement for the specific application. In one embodiment, the inorganic UV-absorbing material is provided in an amount ranging from about 1 wt. % to about 50 wt. %; from about 7 wt. % to about 40 wt. %; from about 10 to about 30 wt. %; even from about 14 to about 20 wt. % based on the dry weight of the film after curing of the coating. Here, as elsewhere in the specification and claims, numerical values may be combined to form new and unspecified ranges.

The catalyst can be added to the topcoat formulation as desired for a particular purpose or intended application. Generally, the catalyst should be added in an amount that will not affect or impair the physical properties of the coating, but in a sufficient amount effective to catalyze the curing reaction. In one embodiment, the catalyst is provided in an amount ranging from about 1 ppm to about 75 ppm; from about 10 ppm to about 70 ppm; even from about 20 ppm to about 60 ppm. Here, as elsewhere in the specification and claims, numerical values may be combined to form new and unspecified ranges. The “ppm” value of the catalyst may be defined as total moles of catalyst per total weight solid of the coating.

The cure catalyst is not particularly limited and any suitable catalyst for curing the coating composition can be used. In one embodiment, the catalyst is a thermal cure catalyst chosen from an alkyl ammonium carboxylate. The alkyl ammonium carboxylate may be a di-, tri-, or tetra-ammonium carboxylate. In one embodiment, the catalyst is chosen from a tetrabutylammonium carboxylate of the formula: [(C₄H₉)₄N]⁺[OC(O)—R]⁻, wherein R is selected from the group consisting of hydrogen, alkyl groups containing about 1 to about 8 carbon atoms, and aromatic groups containing about 6 to 20 carbon atoms. In embodiments, R is a group containing about 1 to 4 carbon atoms, such as methyl, ethyl, propyl, butyl, and isobutyl. Exemplary catalysts are tetra-n-butylammonium acetate (TBAA), tetra-n-butylammonium formate, tetra-n-butylammonium benzoate, tetra-n-butylammonium-2-ethylhexanoate, tetra-n-butylammonium-p-ethylbenzoate, and tetra-n-butylammonium propionate, or a combination of two or more thereof. Particularly suitable catalysts are tetra-n-butylammonium acetate and tetra-n-butylammonium formate, tetramethylammonium acetate, tetramethylammonium benzoate, tetrahexylammonium acetate, dimethylanilium formate, dimethylammonium acetate, tetramethylammonium carboxylate, tetramethylammonium-2-ethylhexanoate, benzyltrimethylammonium acetate, tetraethylammonium acetate, tetraisopropylammonium acetate, triethanol-methyl ammonium acetate, diethanoldimethylammonium acetate, monoethanoltrimethylammonium acetate, ethyltriphenylphosphonium acetate or a combination thereof.

In an embodiment, the primer composition comprises a material suitable for facilitating adhesion of the topcoat material to the substrate. The primer material is not particularly limited, and may be chosen from any suitable primer material. In one embodiment, the primer is chosen from homo and copolymers of alkyl acrylates, polyurethanes, polycarbonates, polyvinylpyrroli done, polyvinylbutyrals, poly(ethylene terephthalate), poly(butylene terephthalate), or a combination of two or more thereof. In one embodiment, the primer may be polymethylmethacrylate.

In one embodiment, the coating system is provided as a primerless system, and the inorganic UV-absorbing material and catalyst are incorporated directly into the coating composition. In one embodiment, the coating system comprises a primer coating and a topcoat coating layer, and the inorganic UV-absorbing material and catalyst are provided in the topcoat layer.

The catalyst can be added to the coating composition directly or can be dissolved in a solvent or other suitable carrier. The solvent may be a polar solvent such as methanol, ethanol, n-butanol, t-butanol, n-octanol, n-decanol, 1-methoxy-2-propanol, isopropyl alcohol, ethylene glycol, tetrahydrofuran, dioxane, bis(2-methoxyethyl)ether, 1,2-dimethoxyethane, acetonitrile, benzonitrile, methylethyl ketone, dimethylformamide (DMF), dimethyl sulfoxide (DMSO), N-methylpyrrolidinone (NMP), and propylene carbonate or a combination thereof.

The coating compositions may include other materials or additives to provide the coating with desired properties for a particular purpose or intended application. For example, the primer composition may also include one or more other additives such as hindered amine light stabilizers, antioxidants, dyes, flow modifiers, and leveling agents. Surfactants are commonly added as a flow modifier/leveling agent in coating compositions. The composition of the invention can also include surfactants as leveling agents. Examples of suitable surfactants include, but are not limited to, fluorinated surfactants such as FLUORAD™ from 3M Company of St. Paul, Minn., and silicone polyethers under the designation Silwet® and CoatOSil® available from Momentive Performance Materials, Inc. of Waterford, N.Y. and polyether-polysiloxane copolymers such as BYK®-331 manufactured by BYK-Chemie. Suitable antioxidants include, but are not limited to, hindered phenols (e.g. IRGANOX® 1010 from Ciba Specialty Chemicals).

The primer composition can be prepared by simply mixing the UV-absorbing agent, the polymeric primer material, and, optionally, other materials and/or additives as ingredients in a solvent. The order of mixing of the components is not critical. The mixing can be achieved through any means known to a person skilled in the art, for example, milling, blending, stirring, and the like. In accordance with the present technology, the topcoat layer comprises an inorganic UV-absorbing material and a catalyst.

In an embodiment, the topcoat coating composition is chosen, in one embodiment, from a material suitable for providing a topcoat. The coating composition is a silicone topcoat. Non-limiting examples of silicone coatings that provide a Hardcoat composition are dispersions of a siloxanol resin and a colloidal metal oxide dispersions. In one embodiment, the siloxanol resin is derived from a partial condensate of a silanol and an alkoxysilsane. Examples of suitable colloidal metal oxides include, but are not limited to, colloidal silica, colloidal cerium oxide, or a combination of two or more thereof.

Siloxanol resin based colloidal silica dispersions are described, for example, in U.S. patent application Ser. No. 13/036,348, U.S. Pat. No. 8,637,157, U.S. Pat. No. 5,411,807, and U.S. Pat. No. 5,349,002, the entire disclosures of which are incorporated herein by reference in their entirety.

Siloxanol resin based colloidal silica dispersions are known in the art. Generally, these compositions have a dispersion of colloidal silica in an aliphatic alcohol/water solution of the partial condensate of an organoalkoxysilane. Suitable organoalkoxysilanes include those of the formula (R)aSi(OR′)4-a, where R is a C1-C6 monovalent hydrocarbon radical, R′ is R or hydrogen, and a is a whole number equal to 0 to 2 inclusive. In one embodiment, the organoalkoxysilane is an alkyltrialkoxysilane, which can be, but is not limited to, methyltrimethoxysilane. Other examples of suitable organoalkoxysilanes for the resin include, but are not limited to, tetraethoxysilane, ethyltriethoxysilane, diethyldiethoxysilane, tetramethoxysilane, methyltrimethoxysilane, dimethyldimethyoxysilane, etc. Aqueous colloidal silica dispersions generally have a particle size in the range of about 5 to about 150 nanometers in diameter. These silica dispersions are prepared by methods well-known in the art and are commercially available. Depending upon the percent solids desired in the final coating composition, additional alcohol, water, or a water-miscible solvent can be added. Generally, the solvent system should contain from about 20 to about 75 weight percent alcohol to ensure solubility of the siloxanol formed by the condensation of the silanol. If desired, a minor amount of an additional water-miscible polar solvent can be added to the water-alcohol solvent system. The composition is allowed to age for a short period of time to ensure formation of the partial condensate of the silanol, i.e., the siloxanol. Upon generating the hydroxyl substituents of these silanols, a condensation reaction begins to form silicon-oxygen-silicon bonds. This condensation reaction is not exhaustive. The siloxanes produced retain a quantity of silicon-bonded hydroxy groups, which is why the polymer is soluble in the water-alcohol solvent mixture. This soluble partial condensate can be characterized as a siloxanol polymer having silicon-bonded hydroxyl groups and —SiO— repeating units. The degree of condensation is characterized by the T³/T² ratio wherein T³ represents the number of silcon atoms in the siloxanol polymer that have three siloxane bonds, having condensed with three other alkoxysilane or silanol species. T² represents the number of silicon atoms in the siloxanol polymer that have two siloxane bonds, having condensed with other with two other alkoxysilane or silanol species and one alkoxy or hydroxy group remaining. The T³/T² ratio can range from 0 (no condensation) to ∞ (complete condensation). The T³/T² for siloxanol resin based coating solutions is preferably 0.2 to 3.0, and more preferably from about 0.6 to about 2.5.

Examples of aqueous/organic solvent borne siloxanol resin/colloidal silica dispersions can be found in U.S. Pat. No. 3,986,997 to Clark which describes acidic dispersions of colloidal silica and hydroxylated silsesquioxane in an alcohol-water medium with a pH of about 3-6. Also, U.S. Pat. No. 4,177,315 to Ubersax discloses a coating composition comprising from about 5 to about 50 weight percent solids comprising from about 10 to about 70 weight percent silica and about 90 to about 30 weight percent of a partially polymerized organic silanol of the general formula RSi(OH)₃, wherein R is selected from methyl and up to about 40% of a radical selected from the group consisting of vinyl, phenyl, gamma-glycidoxypropyl, and gamma-methacryloxypropyl, and from about 95 to about 50 weight percent solvent, the solvent comprising about from about 10 to about 90 weight percent water and from about 90 to about 10 weight percent lower aliphatic alcohol, the coating composition having a pH of greater than about 6.2 and less than about 6.5. U.S. Pat. No. 4,476,281 to Vaughn describes hardcoat composition having a pH from 7.1-7.8. In another example, U.S. Pat. No. 4,239,798 to Olson et al. discloses a thermoset, silica-filled, organopolysiloxane top coat, which is the condensation product of a silanol of the formula RSi(OH)₃ in which R is selected from the group consisting of alkyl radicals of 1 to 3 carbon atoms, the vinyl radical, the 3,3,3-trifluoropropyl radical, the gamma-glycidoxypropyl radical and the gamma-methacryloxypropyl radical, at least about 70 weight percent of the silanol being CH₃Si(OH)₃. The content of each of the foregoing patents is herein incorporated by reference.

The siloxanol resin/colloidal silica dispersions described herein can contain partial condensates of both organotrialkoxysilanes and diorganodialkoxysilanes and can be prepared with suitable organic solvents, such as, for example, 1 to 4 carbon alkanol, such as methanol, ethanol, propanol, isopropanol, butanol; glycols and glycol ethers, such as propyleneglycolmethyl ether and the like and mixtures thereof.

Examples of suitable commercial silicone coating materials include, but are not limited to, SilFORT™ AS4700, SilFORT™ PHC 587, SilFORT™ AS4000, SilFORT™ SHC2050 available from Momentive Performance Materials Inc., SILVUE™ 121, SILVUE™ 339, SILVUE™ MP100, CrystalCoat™ CC-6000 available from SDC Technologies, and HI-GARD™ 1080 available from PPG, etc.

Other additives such as hindered amine light stabilizers, antioxidants, dyes, flow modifiers and leveling agents or surface lubricants can be used in the topcoat. Other colloidal metal oxides can be present at up to about 10% by weight, more preferably from about 1% to about 10% by weight, of the aqueous/organic solvent borne siloxanol resin/colloidal silica dispersion and can include metal oxides such as, antimony oxide, cerium oxide, aluminum oxide, zinc oxide, and titanium dioxide. Additional organic UV absorbers may be used in the topcoat.

The UV absorbers can also be chosen from a combination of inorganic UV absorbers and organic UV absorbers. Examples of suitable organic UV absorbers, include but are not limited to, those capable of co-condensing with silanes. Such UV absorbers are disclosed in U.S. Pat. Nos. 4,863,520, 4,374,674, 4,680,232, and 5,391,795 which are herein incorporated by reference in their entireties. Specific examples include 4-[gamma-(trimethoxysilyl) propoxyl]-2-hydroxy benzophenone and 4-[gamma-(triethoxysilyl) propoxyl]-2-hydroxy benzophenone and 4,6-dibenzoyl-2-(3-triethoxysilylpropyl) resorcinol. When the UV absorbers that are capable of co-condensing with silanes are used, the UV absorber should co-condense with other reacting species by thoroughly mixing the coating composition before applying it to a substrate. Co-condensing the UV absorber prevents coating performance loss caused by the leaching of free UV absorbers to the environment during weathering.

In one embodiment, the silicone hardcoat system comprises from about 10% to about 50% by weight of solids. In one embodiment, the silicone hardcoat system comprises from about 15% to about 45% by weight of solids. In one embodiment, the silicone hardcoat system comprises from about 20% to about 30% by weight of solids.

The coating can be applied to any suitable substrate. Examples of suitable substrates include, but are not limited to, organic polymeric materials such as acrylic polymers, e.g., poly(methylmethacrylate), polyamides, polyimides, acrylonitrile-styrene copolymer, styrene-acrylonitrile-butadiene terpolymers, polyvinyl chloride, polyethylene, polycarbonates, copolycarbonates, high-heat polycarbonates, and any other suitable material or combination of materials.

The primer may be coated onto a substrate by flow coat, dip coat, spin coat or any other methods known to a person skilled in the field, it is allowed to dry by removal of any solvents, for example by evaporation, thereby leaving a dry coating. The primer may subsequently be cured. Additionally, a topcoat (e.g., a hardcoat layer) may be applied on top of the dried primer layer by flow coat, dip coat, spin coat or any other methods known to a person skilled in the field. Optionally, a topcoat layer may be directly applied to the substrate without a primer layer. The number of coating layers or primer layers may also be selected as desired for a particular purpose or intended application. For example, it may be possible to employ a single coating layer, two or more coating layers, three or more coating layers, etc. In one embodiment, the hardcoat may be formed by 1 to 5 coating layers, 2-4 coating layers, or 3 coating layers. Multiple coating layers may be formed by applying a first coating layer, sufficiently drying the coating, and forming a subsequent coating layer over the adjacent coating layer. This may be done as many times as required to provide the desired number of coating layers. It will be appreciated that the coating layers may have the same or different compositions from one another. Similarly, it is within the scope of the present technology that multiple primer layers may be employed to promote adhesion of a coating layer to a substrate.

The following examples illustrate embodiments of materials in accordance with the disclosed technology. The examples are intended to illustrate embodiments of the disclosed technology, and are not intended to limit the claims or disclosure to such specific embodiments.

### EXAMPLES

### Preparation of CeO₂ Containing Coating Solutions

### Example S-1. Preparation of Silicone Hardcoat Solution Containing Cerium Oxide

Cerium oxide containing resin solutions were prepared by hydrolysis of methyl trimethoxy silane (MTMS) in a solution of colloidal cerium oxide. A small glass bottle was charged with colloidal cerium oxide dispersion (Sigma Aldrich: 20 wt. % solids, 2.5 wt. % acetic acid stabilized, aqueous). MTMS was added to the chilled cerium oxide solution over approximately 20 minutes. The mixture was allowed to stand at room temperature and was stirred for several hours. Next, 1-methoxy-2-propanol (MP) was mixed in and the reaction was allowed to stand at room temperature for several more days. The reaction mixture was then further reduced with isopropanol. The cure catalysts were added to the solution followed by other additives, e.g., flow control additives. Table 1 illustrates an example formulation of the cerium oxide sol. The charges of cerium oxide and catalyst used to formulate the cerium oxide sol are adjusted to provide the desired loading of cerium oxide and catalyst in the coating composition as mentioned in Table 4. The formulation was aged sufficiently before being applied as topcoat.

TABLE 1
Example S-1 Cerium Oxide containing Silicone Hardcoat

| | Charge (g) | | |
|---|---|---|---|
| Material | S-1a | S-1b | S-1c |
| MTMS | 25.40 | 12.71 | 12.70 |
| Colloidal CeO₂ (20%, 2.5% AcOH) | 12.70 | 6.37 | 6.35 |
| MP | 19.10 | 9.54 | 4.75 |
| IPA | 42.92 | 21.44 | 11.06 |
| BYK ® 302 polyether modified | 0.01 | 0.01 | 0.01 |
| polydimethylsiloxane | | | |

### Example S-2. Alternative Preparation of Silicone Hardcoat Containing Cerium Oxide

A cerium oxide-siloxanol hydrolyzate was prepared by charging the cerium oxide sol (Sigma Aldrich, 20 wt. % solids, 2.5 wt. % acetic acid stabilized, aqueous) to an Erlenmeyer flask then cooling in an ice bath to <10° C. Methyl trimethoxy silane was then added to the cool CeO₂ sol over 30 minutes while stirring the mixture. The resulting hydrolyzate was allowed to warm to room temperature and stir for an additional 16 hours. The hydrolyzate was then diluted by adding 1-methoxy-2-propanol and iso-propanol and allowed to stand for three days at room temperature to age. The pH of the hydrolyzate was then adjusted to 5.1 by adding NH₄OH solution. To the Cerium Oxide-siloxanol hydrolyzate mixture was then added BYK® 331 polyether modified polydimethylsiloxane (available from Byk-Chemie GmbH) and tetrabutylammonium acetate (as a 39.9 wt. % solution in water). Table 2 shows the charges used to formulate of the cerium oxide siloxanol coating solution Example S-2, this formulation had a measured solids of 25.8 wt. %. The formulation was further aged prior to final formulation with catalyst as mentioned in Table 4.

TABLE 2
Example S-2: Cerium Oxide containing silicone hardcoat

| Material | Charge (g) |
|---|---|
| 20% Cerium Oxide Sol | 400.33 |
| MTMS | 852.26 |
| MP | 382.00 |
| IPA | 362.29 |
| 14.6 wt. % ammonia (in water) | 4.41 |
| BYK ® 331 polyether modified | 0.40 |
| polydimethylsiloxane | |

### Example S-3. Preparation of Silicone Hardcoat Containing Both Cerium Oxide and Colloidal Silica

A cerium oxide-siloxanol hydrolyzate was prepared by charging the cerium oxide sol (Sigma Aldrich, 20 wt. % solids, 2.5 wt. % acetic acid stabilized, aqueous) to an erylenmyer flask then cooling in an ice bath to <10° C. Methyltrimethoxy silane was then added to the cool CeO₂ sol over 30 minutes while stirring the mixture. The resulting hydrolyzate was allowed to warm to room temperature and stir for an additional 16 hours. The hydrolyzate was then diluted by adding 1-methoxy-2-propanol. The hydrolyzate was then aged by allowing it to stand for three days at room temperature.

A colloidal silica-siloxanol hydrolyzate was prepared by charging the colloidal silica sol (Nalco 1034A, 34.7 wt. % solids, aqueous) to an erylenmyer flask then cooling in an ice bath to <10° C. Methyltrimethoxy silane was then added to the cool SiO₂ sol over 30 minutes while stirring the mixture. The resulting hydrolyzate was allowed to warm to room temperature and stir for and additional 16 hours. The hydrolyzate was then diluted by adding iso-propanol. The hydrolyzate was then aged by allowing it to stand for three days at room temperature. The cerium oxide containing hydrolyzate and colloidal silica containing hydrolyzate were then combined and stirred to completely mix them. The pH of the combined hydrolyzate was then adjusted to 5.1 by adding NH₄OH solution. To the CeO₂/SiO₂ siloxanol hydrolyzate mixture was then added BYK® 331 polyether modified polydimethylsiloxane. Table 3 shows the charges used to formulate the mixed cerium oxide/colloidal silica siloxanol coating solution, this formulation had a measured solids of 25.6 wt. %. The hydrolyzate was further aged prior to final formulation with catalyst as mentioned in Table 4

TABLE 3
Example S-3: Ceria/Silica containing silicone hardcoat

| Material | Charge (g) |
|---|---|
| Cerium oxide siloxanol | |
| 20% Cerium Oxide Sol | 400.85 |
| MTMS | 419.15 |
| MP | 380.00 |
| Colloidal Silica siloxanol | |
| 34.7% Colloidal Silica Sol | 187.31 |
| MTMS | 301.35 |
| IPA | 311.34 |
| Final coating solution | |
| Cerium oxide siloxanol | 1200.00 |
| Colloidal Silica siloxanol | 800.00 |
| 14.6 wt. % ammonia (in water) | 4.42 |
| BYK ® 331 polyether modified | 0.40 |
| polydimethylsiloxane. | |

### Hardcoat Examples 1-19

The Examples shown in Table 4 were formulated using formulations S-1, to S-3 along with catalyst solution loading mentioned in the table and coated for testing. The formulation was further aged prior to final formulation with catalyst.

TABLE 4
Formulation of catalyzed hardcoat Examples

| | CeO2 Coating Solution | | | | Catalyst | |
|---|---|---|---|---|---|---|
| | | Charge | pH adjustment | | | Charge |
| Example | Type | (g) | Base | Final pH | Type | (g) |
| 1 | S-1b | 50.03 | — | 3.79 | 39.9% TBAA (in water) | 0.0510 |
| 2 | S-1a | 100.13 | — | 3.55 | 39.9% TBAA (in water) | 0.1055 |
| 3 | S-1a | 100.14 | N-(beta-Aminoethyl)- | 5.00 | 39.9% TBAA (in water) | 0.1055 |
| | | | gamma-aminopropyl | | | |
| | | | trimethoxy silane | | | |
| 4 | S-1a | 100.12 | Sodium Acetate | 6.10 | 39.9% TBAA (in water) | 0.1160 |
| 5 | S-1a | 100.11 | — | 3.93 | 39.9% TBAA (in water) | 0.2489 |
| 6 | S-1a | 100.13 | — | 3.92 | 39.9% TBAA (in water) | 0.3016 |
| 7 | S-1a | 100.21 | — | 4.20 | 39.9% TBAA (in water) | 0.4110 |
| 8 | S-1a | 100.16 | — | 4.52 | 39.9% TBAA (in water) | 0.5066 |
| 9 | S-1c | 34.89 | — | | 39.9% TBAA (in water) | 0.2561 |
| 10 | S-1c | 34.72 | — | | 39.9% TBAA (in water) | 0.3131 |
| 11 | S-1c | 34.90 | — | | 39.9% TBAA (in water) | 0.3699 |
| 12 | S-1a | 100.11 | — | 6.17 | 39.9% TBAA (in water) | 1.0045 |
| 13 | S-1a | 100.23 | — | 6.52 | 39.9% TBAA (in water) | 2.0134 |
| CE-1 | | | | | | |
| AS4700 | | | | | | |
| CE-2 | | — | — | | — | — |
| AS4700 | | | | | | |
| CE-3 | | — | — | | — | — |
| AS4010 | | | | | | |
| 14 | S-2 | 400.00 | NH₄OH | 5.08 | 39.9% TBAA (in water) | 0.4459 |
| 15 | S-2 | 381.99 | NH₄OH | 5.08 | 39.9% TBAA (in water) | 1.9586 |
| 16 | S-2 | 358.92 | NH₄OH | 5.08 | 39.9% TBAA (in water) | 3.3205 |
| 17 | S-3 | 400.00 | NH₄OH | 5.13 | 39.9% TBAA (in water) | 0.4424 |
| 18 | S-3 | 361.49 | NH₄OH | 5.13 | 39.9% TBAA (in water) | 1.8391 |
| 19 | S-3 | 344.38 | NH₄OH | 5.13 | 39.9% TBAA (in water) | 3.1613 |

### Preparation of Primer Formulation

Primer formulations were prepared by mixing a PMMA solution and optionally, additional solvent and a flow control agent. The PMMA solutions were prepared by dissolving PMMA resin in a mixture of 1-methoxy-2-propanol (85 wt. %) and diacetone alcohol (15 wt. %). Solvent dilutions were done with an 85:15 (weight ratio) mixture of 1-methoxy-2-propanol:diacetone alcohol. BYK®-331 is employed as the flow control agent. The primer solids may be in the range of 1-10% by weight. Components were combined in an appropriately sized glass or polyethylene bottle then shaken well to mix. Samples were allowed to stand for at least 1 hour prior to coating application.

### Preparation of Coated Polycarbonate Panels

The Silicone Hardcoat formulations in Table 4 were coated on polycarbonate plates according to the following procedure. Polycarbonate (PC) plaques (6×6×0.3 cm) were cleaned with a stream of N₂ gas to remove any dust particles adhering to the surface followed by rinsing of the surface with isopropanol. The plates were then allowed to dry inside the fume hood for 20 minutes. The primer solutions were then applied to the PC plates by flow coating. The solvent in the primer coating solutions were allowed to flash off in the fume hood for approximately 20 minutes (20-24° C., 35-45% RH) and then places in a preheated circulated air oven for 125° C. for 45 minutes. After cooling to room temperature, the primed PC plates were then flow coated with Silicone Hardcoat solutions mentioned in Table 4, including (AS4700 & AS4010 from Momentive Performance Materials Inc.). After drying for approximately 20 minutes (22° C., 45% RH), the coated plates were placed in a preheated circulated air oven at 125° C. for 45 minutes.

The optical characteristics (Transmission and Haze) were measured using a BYK Gardner Haze Gard™ instrument measurements were made according to ASTM D1003.

Adhesion was measured using a cross hatch adhesion test according to ASTM D3200/D3359. The adhesion is rated on a scale of 5B-0B, with 5B indicative of the highest adhesion. Adhesion after water immersion was done by immersing the coated PC plates in 65° C. water followed by cross hatch adhesion test at different time intervals.

Steel wool abrasion tests were performed by rubbing grade 0000 steel wool under a weight of 1 Kg on the surface of the coated substrate. The initial haze (Hᵢ) of the coated sample was measured prior to steel wool abrasion then again after rubbing back and forth 5 times (H_{f}). The ΔHaze (ΔH) was calculated as, ΔH=H_{f}−Hᵢ.

Taber abrasion testing was done in accordance with ASTM D1003 and D1044, haze measurements were made using a BYK Haze Gard™ plus hazimeter, ΔH values at 500 cycles were recorded. A minimum of three specimens of each experimental sample were tested, the average ΔH(500) is reported.

Hardness (H) and reduced modulus (Eᵣ) values, were obtained from nanoindentation measurements. The use of H/Eᵣ has been documented in the literature (J. Coat. Technol. Res., 13(4), 677-690. DOI 10.1007/s11998-016-9782-8) as a means to predict wear properties of ceramic and metallic nanocomposite coatings. Testing reported here was performed using a Hysitron® TI 900 TriboIndenter® instrument, equipped with a Berkovich geometry probe. The tests were performed in displacement control mode, and the maximum load for an indent was selected to ensure a consistent contact depth of 5.0±0.1% of topcoat film thickness in the location being tested. The test surfaces of the samples were wiped clean with IPA prior to testing. Each measurement consisted of a three segment load function: a load segment (a five second ramp from zero displacement to the target displacement), a hold segment (a five second hold at the target displacement), and an unload segment (a one second unload back to zero displacement.) A minimum of seven measurements were made on each specimen tested, the average value of these measurements for each example is reported. The average relative standard deviation for the reported values was <2%.

The results of the characteristic testing are shown in Tables 5 and 6 below.

TABLE 5

| | | | Abrasion | Adhesion | | |
|---|---|---|---|---|---|---|
| | | | Resistance | | Water Soak | |
| Example | % T | Hᵢ | ΔH (SWA) | Initial | @ (10 d) | days to <4 B |
| 1 | 88.12 | 0.73 | 7.7 | 5 B | 5 B | >30 |
| 2 | 89.5 | 6.1 | 7.8 | 5 B | 5 B | >30 |
| 3* | 88.8 | 1.98 | 3.9 | 5 B | 5 B | >30 |
| 4** | 89.2 | 2.45 | 1.2 | 5 B | 5 B | >30 |
| 5 | 88.82 | 3.7 | Slight | 5 B | 5 B | >18 |
| | | | scratch | | | |
| 6 | 90 | 1.68 | 1.9 | 5 B | 5 B | >30 |
| 7 | 89.5 | 2.22 | 1.5 | 5 B | 5 B | >30 |
| 8 | 90.3 | 1.68 | 0.5 | 5 B | 5 B | >30 |
| 9 | 89.62 | 0.55 | 0.7 | 5 B | 5 B | >30 |
| 10 | 89.82 | 0.44 | 0.5 | 5 B | 4 B | 10 |
| 11 | 89.9 | 0.41 | 0.6 | 5 B | 4 B | 10 |
| 12 | 90.22 | 2.52 | No scratch | 5 B | 5 B | >18 |
| 13 | 90.2 | 4.23 | No scratch | 5 B | 0 B | 4 |
| CE-1 | 89.7 | 0.69 | 0.19 | 5 B | 5 B | >30 |
| (AS4700) | | | | | | |

TABLE 6

| | | Taber | | Adhesion | | |
|---|---|---|---|---|---|---|
| | | ΔH | | | Water Soak | |
| Example | Hi | (500) | H/Er | Initial | @ (10 d) | days to <4 B |
| 9 | — | 4.7 | — | 5 B | 4 B | >30 |
| 10 | — | 8.1 | — | 5 B | 4 B | 10 |
| 11 | — | 9.4 | — | 5 B | 5 B | 10 |
| CE-1 | — | 2.5 | — | 5 B | 5 B | >32 |
| (AS4700) | | | | | | |
| CE-2 | 0.28 | 1.5 | 0.16 | 5 B | 5 B | >32 |
| (AS4700) | | | | | | |
| CE-3 | 0.25 | 4.5 | 0.12 | 5 B | 5 B | >32 |
| (AS4010) | | | | | | |
| 14 | 0.33 | 38.7 | 0.03 | 5 B | 2 B | 6 |
| 15 | 0.31 | 7.7 | 0.08 | 5 B | 5 B | >32 |
| 16 | 0.28 | 3.8 | 0.14 | 5 B | 5 B | >32 |
| 17 | 0.48 | 20.9 | 0.03 | 5 B | 4 B | 11 |
| 18 | 0.48 | 6.1 | 0.10 | 5 B | 5 B | >32 |
| 19 | 0.39 | 2.9 | 0.13 | 5 B | 5 B | >32 |

### Notes to Tables 5 and 6:

Entry CE-1, CE-2, CE-3—Control samples are Standard silicon Hardcoat formulation like AS4700, AS4010 (Momentive Performance Materials) without Cerium oxide
* pH Adjusted with A1120 (N-(beta-Aminoethyl)-gamma-aminopropyl trimethoxy silane)
** pH adjusted with Sodium Acetate
Except for all control formulations, all other formulations contain 16-17 wt. % Cerium Oxide (in dry film)
SWA—Steel wool abrasion test

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

What is claimed is:

1. A coating system comprising (a) at least one curable silicone resin material, (b) from about 1 wt. % to about 50 wt. % of at least one inorganic UV-absorbing material based on the dry weight of a film after curing the coating system, and (c) from about 1 ppm to about 75 ppm of at least one catalyst.

2. The coating system of claim 1, wherein the inorganic UV-absorbing material is chosen from cerium oxide, titanium oxide, zinc oxide, or a combination of two or more thereof.

3. The coating system of claim 1, wherein the catalyst is chosen from tetrabutylammonium carboxylate, tetra-n-butylammonium acetate (TBAA), tetra-n-butyl ammonium formate, tetra-n-butylammonium benzoate, tetra-n-butylammonium-2-ethylhexanoate, tetra-n-butylammonium-p-ethylbenzoate, and tetra-n-butylammonium propionate, tetra-n-butylammonium acetate, tetra-n-butylammonium formate, tetramethylammonium acetate, tetramethylammonium benzoate, tetrahexylammonium acetate, dimethylanilium formate, dimethylammonium acetate, tetramethylammonium carboxylate, tetramethylammonium-2-ethylhexanoate, benzyltrimethylammonium acetate, tetraethyl ammonium acetate, tetraisopropylammonium acetate, triethanol-methylammonium acetate, diethanoldimethylammonium acetate, monoethanoltrimethylammonium acetate, ethyltriphenylphosphonium acetate, or a combination of two or more thereof.

4. The coating system of claim 1, wherein the inorganic UV-absorbing material is provided in an amount ranging from about 7 wt. % to about 40 wt. % based on the dry weight of film after curing the coating system.

5. The coating system of claim 1, wherein the inorganic UV-absorbing material is provided in an amount ranging from about 10 wt. % to about 30 wt. % based on the dry weight of film after curing the coating system.

6. The coating system of claim 1, wherein the inorganic UV-absorbing material is provided in an amount ranging from about 14 wt. % to about 20 wt. % based on the dry weight of film after curing the coating system.

7. The coating system of claim 1, wherein the catalyst is provided in an amount ranging from about 1 ppm to about 70 ppm.

8. The coating system of claim 1, wherein the catalyst is provided in an amount ranging from about 20 ppm to about 60 ppm.

9. The coating system of claim 1, wherein the silicone resin comprises a siloxanol resin comprising colloidal silica.

10. The coating system of claim 1, wherein the UV-absorbing material is cerium oxide and the coating system further comprises silica.

11. A coated article comprising:
a polymeric substrate; and
a coating system comprising a silicone hardcoat layer disposed on at least a portion of a surface of the polymeric substrate, the silicone hardcoat layer comprising from about 1 wt. % to about 50 wt. % of at least one inorganic UV-absorbing material based on the dry weight of the coating system, and from about 1 ppm to about 75 ppm of at least one catalyst.

12. The article of claim 11, wherein the inorganic UV-absorbing material is chosen from cerium oxide, titanium oxide, zinc oxide, or combinations of two or more thereof.

13. The article of claim 11, wherein the catalyst is chosen from tetrabutylammonium carboxylate, tetra-n-butylammonium acetate (TBAA), tetra-n-butylammonium formate, tetra-n-butylammonium benzoate, tetra-n-butylammonium-2-ethylhexanoate, tetra-n-butylammonium-p-ethylbenzoate, and tetra-n-butylammonium propionate, tetra-n-butylammonium acetate, tetra-n-butylammonium formate, tetramethylammonium acetate, tetramethylammonium benzoate, tetrahexylammonium acetate, dimethylanilium formate, dimethylammonium acetate, tetramethylammonium carboxylate, tetramethylammonium-2-ethylhexanoate, benzyltrimethylammonium acetate, tetraethylammonium acetate, tetraisopropylammonium acetate, triethanol-methylammonium acetate, diethanoldimethylammonium acetate, monoethanoltrimethylammonium acetate, ethyltriphenylphosphonium acetate, or combinations of two or more thereof.

14. The article of claim 11, wherein the inorganic UV-absorbing material is provided in an amount ranging from about 7 wt. % to about 40 wt. % based on the dry weight of film after curing the coating system.

15. The article of claim 11, wherein the inorganic UV-absorbing material is provided in an amount ranging from about 10 wt. % to about 30 wt. % based on the dry weight of film after curing the coating system.

16. The article of claim 11, wherein the inorganic UV-absorbing material is provided in an amount ranging from about 14 wt. % to about 20 wt. % based on the dry weight of film after curing the coating system.

17. The article of claim 11, wherein the catalyst is provided in an amount ranging from about 10 ppm to about 70 ppm.

18. The article of claim 11, wherein the catalyst is provided in an amount ranging from about 20 ppm to about 60 ppm.

19. The article of claim 11 further comprising a primer layer interposed between the silicone hardcoat layer and the polymeric substrate.

20. The article of claim 18, wherein the primer layer comprises at least one polymer chosen from an alkyl acrylates, a polyurethane, a polycarbonate, polyvinylpyrrolidone, a polyvinylbutyral, a poly(alkylene terephthalate), or a combination of two or more thereof.

21. The article of claim 20, wherein the primer layer comprises polymethylmethacrylate.

22. The article of claim 11, wherein the polymeric substrate is chosen from an acrylic polymer, a polyamide, a polyimide, an acrylonitrile-styrene copolymer, a styrene-acrylonitrile-butadiene terpolymer, a polyvinyl chloride, a polyethylene, a polycarbonate, a copolycarbonate, a high-heat polycarbonate, or a combination of two or more thereof.

23. A method of forming a curable silicone hardcoat composition comprising adding (i) from about 1 wt. % to about 50 wt. % of at least one inorganic UV-absorbing material based on the dry weight of a film after curing the composition, and (ii) from about 1 ppm to about 75 ppm of at least one catalyst to a curable silicone material.

24. A method of preparing a coated article comprising:
applying a silicone hardcoat composition to at least a portion of a surface of an article, the silicone hardcoat composition comprising a) at least one curable silicone resin material, (b) from about 1 wt. % to about 50 wt. % of at least one inorganic UV-absorbing material based on the dry weight of a film after curing the coating system, and (c) from about 1 ppm to about 75 ppm of at least one catalyst; and
curing the silicone hardcoat composition to form a cured coating layer.

25. The method of claim 24, wherein the cured coating layer is further treated by a vacuum deposition processes.
